(19) United States
(12) Patent Application Publication
(10) Pub. No.: US 2009/0071357 A1
(43) Pub. Date: Mar. 19, 2009

(54) PRINTING UNIT OF A WEB-FED ROTARY PRINTING PRESS

(75) Inventor: Wolfgang KAESER, Mertingen (DE)

Correspondence Address: CROWELL & MORING LLP;INTELLECTUAL PROPERTY GROUP, P.O. BOX 14300, WASHINGTON, DC, 20044-4300, US

(73) Assignee: manroland AG, Offenbach/Main (DE)

(21) Appl. No.: 12/209,929

(22) Filed: Sep. 12, 2008

(30) Foreign Application Priority Data
Sep. 14, 2007 (DE) 10 2007 043 842.9

(51) Int. Cl. B41F 31/00

(52) U.S. Cl. 101/350.5

(57) ABSTRACT

A printing unit of a web-fed rotary printing press with several printing couples is disclosed. Each printing couple features a transfer cylinder, a plate cylinder, an inking couple and preferably a dampening unit, where the transfer cylinder, the plate cylinder, and rollers of the inking couple and if applicable of the dampening unit of each printing couple, are coupled on the drive side via gears and jointly positioned on side walls of the printing unit. Independently driven ink fountain rollers of the inking couples together with an ink fountain as well as a film roller of the inking couples are positioned on separate side walls in such a way that, in the region of each printing couple, the ink fountain roller, the ink fountain as well as the film roller of the respective inking couple are displaceable relative to the cylinders and rollers of the printing couples.

This application claims the priority of German Patent Document No. 10 2007 043 842.9, filed Sep. 14, 2007, the disclosure of which is expressly incorporated by reference herein.

### BACKGROUND AND SUMMARY OF THE INVENTION

The invention relates to a printing unit of a web-fed rotary printing press.

Printing units of web-fed rotary printing presses, in particular of newspaper printing presses or even commercial web printing presses, normally have several printing couples, wherein each printing couple is comprised of at least one transfer cylinder, one plate cylinder and one inking couple as well as preferably one dampening unit. Printing couples without dampening units are also known. In addition, these types of printing units can also have impression cylinders, which are also designated as satellite cylinders, wherein such an impression cylinder can cooperate with one or more transfer cylinders of different printing couples. Besides printing units that have these types of impression cylinders, printing units that do not have any impression cylinders are known, wherein, in the case of these types of printing units without impression cylinders, the transfer cylinders of two printing couples roll off of one another. The transfer cylinders are also designated as blanket cylinders and the plate cylinders as engraving cylinders. The plate cylinders or engraving cylinders bear printing plates.

Particularly in the case of newspaper printing presses, a trend has been noted that printing units with increasingly lower construction heights are in demand. The lower the construction height of a printing unit is, the wider such a printing unit is, whereby ultimately a person working on the printing unit, namely a printer, has trouble performing operational and maintenance tasks, such as changing a printing plate or a blanket, for example, on the plate cylinders of the printing units or even on the transfer cylinders of the same.

Separating the printing units into modules is already known in practice, in order to nevertheless facilitate access particularly to the cylinders of the printing unit in the case of these types of printing units with a low construction height but with a large width. Thus, the printing units are separated, for example, into cylinder modules and inking couple modules, wherein, in the region of each printing couple of a printing unit, the entire inking couple can be displaced relative to the plate cylinder as well as to the transfer cylinder. However, in the case of these types of divided printing units, the propulsion of the individual modules causes difficulties.

Starting herefrom, the present invention is based on the objective of creating a novel printing unit of a web-fed rotary printing press.

According to the invention, independently driven ink fountain rollers of the inking couples together with an ink fountain as well as a film roller of the inking couples are positioned on separate side walls in such a way that, in the region of each printing couple, the ink fountain roller, the ink fountain as well as the film roller of the respective inking couple are displaceable relative to the cylinders and rollers of the printing couples, which cylinders and rollers are coupled via a gear train on the drive side, in order to facilitate access to the cylinders and rollers of the printing couples that are coupled via a gear train on the drive side.

Within the scope of the present invention, a printing unit of a web-fed rotary printing press is divided into modules in such a way that, on the one hand, all cylinders and rollers coupled via a gear train on the drive side are jointly positioned on side walls of the printing couple in the form of a first module, and that, on the other hand, ink fountain rollers of the inking couples together with an ink fountain as well as a film roller of the inking couples are positioned on separate side walls as second modules, so that, in the region of each inking couple of a printing unit, the ink fountain roller, the ink fountain as well as the film roller can be displaced relative to the cylinders and rollers of the printing couples coupled via a gear train on the drive side.

As a result, it is possible to use the proven drive technology using gears or gear trains in a printing unit despite dividing or separating the same into several modules. All cylinders and rollers that are to be driven via gears are combined into a module and cooperate inseparably. Only the ink fountain, the independently driven ink fountain roller, the film roller as well as any rollers of each inking couple that are carried along via friction form separate modules that are displaceable.

Advantageous developments of the invention are disclosed in the following description. Without being limited hereto, exemplary embodiments of the invention are explained in greater detail on the basis of the drawing.

### BRIEF DESCRIPTION OF THE DRAWING

FIG. 1 is a schematic view of two inventive printing units of a web-fed rotary printing press positioned in a stacked manner in the form of a printing tower.

### DETAILED DESCRIPTION OF THE DRAWING

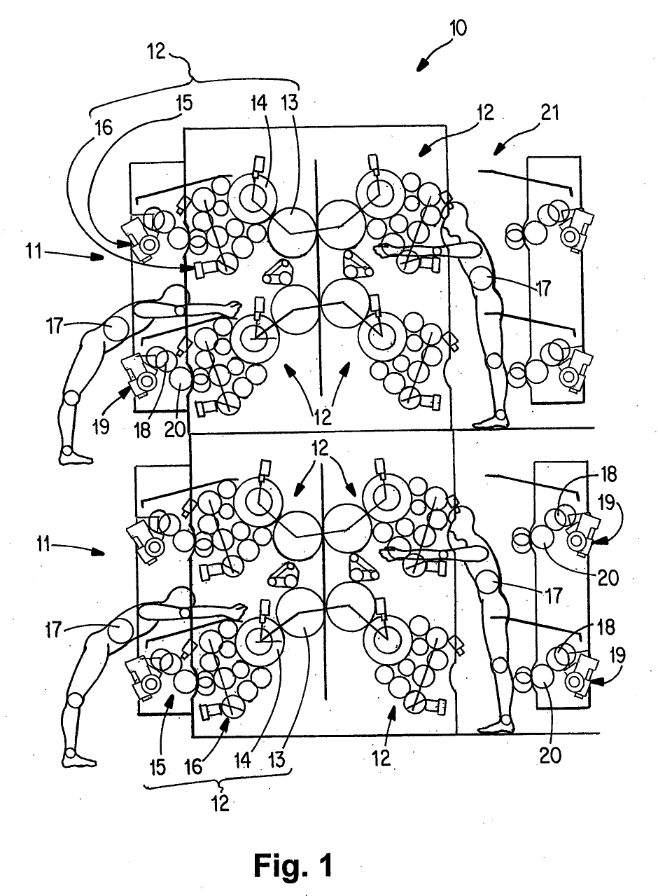

FIG. 1 depicts a schematic section of a web-fed rotary printing press in the region of a printing tower 10, which is formed by two inventive printing units 11 positioned in a stacked manner. Each of the two printing units 11 is comprised of four printing couples 12, wherein each of the printing couples 12 is comprised of a transfer cylinder 13, a plate cylinder 14, an inking couple 15 as well as a dampening unit 16.

In the depicted exemplary embodiment, the transfer cylinders 13 of two respective printing couples 12 positioned horizontally side-by-side roll off forming printing positions for a to-be-printed printing substrate. The printing units 11 in the depicted exemplary embodiment are consequently 8-cylinder printing units.

As the left half of FIG. 1 in particular shows, the printing units 11 are printing units with a low construction height but with a large width, so that it is almost impossible for a printer 17 to perform maintenance work on the plate cylinders 14 as well as on the transfer cylinders 13. For this purpose, the printing units 11 are separated into modules, wherein the type of separation of the printing unit into modules constitutes the core of the present invention.

According to the invention, the printing unit 11 is comprised of a first module, which includes all cylinders and rollers that are coupled via gears or via a gear train on the drive side, i.e., the transfer cylinders 13, the plate cylinders 14 as well as all rollers of the inking couple 15 as well as of the dampening unit 16 to be driven starting from the transfer cylinder 13 and/or the plate cylinder 14. Rollers driven in a trailing manner via friction by these cylinders and rollers coupled via the gear trains on the drive side can also belong to this module.

Independently driven ink fountain rollers 18, ink fountains 19 as well as film rollers 20 of the inking couples 15 are positioned on separate side walls and form independent modules, and namely in such a way that, in the region of each printing couple 12, the ink fountain roller 18, the ink fountain 19 as well as the film roller 20 of the respective inking couple 15 is displaceable relative to the cylinders and rollers of the printing couples, which cylinders and rollers are coupled via a gear train on the drive side, and namely according to FIG. 1 in a direction which runs perpendicular to the longitudinal center axis of the transfer cylinders 13 or plate cylinders 14. As a result, as shown on the right side of FIG. 1, a free space 21 that a printer 17 can enter is made available between the module with the cylinders and rollers coupled via gear trains on the drive side and the module with the ink fountain rollers, ink fountains and film rollers, thereby facilitating access to the cylinders and rollers of the printing unit 11 coupled via gear trains on the drive side. The modules with the ink fountain rollers 18, ink fountains 19 and film rollers 20 can continue to include the same rollers driven in a trailing manner via friction.

In contrast to the depicted exemplary embodiment, the modules, which are comprised of the ink fountain rollers 18, the ink fountains 19 as well as the film rollers 20, are also displaceable in a direction that runs parallel to the longitudinal center axis of the transfer cylinders 13 or the plate cylinders 14.

In the exemplary embodiment depicted in FIG. 1, in the region of each printing unit 11, the ink fountain rollers 18, the ink fountains 19 as well as the film rollers 20 of two printing couples 12 positioned in a stacked manner are respectively jointly displaceable. In just the same way, it is possible that when, as shown in FIG. 1, two printing units 11 are positioned vertically in a stacked manner to form a printing tower 10, the ink fountain rollers 18, ink fountains 19 and film rollers 20 of the four printing couples positioned in a stacked manner are jointly displaceable.

It is expressly emphasized that the invention is not restricted to printing presses with an eight-cylinder blanket-to-blanket arrangement, but also extends to satellite arrangements.

### LIST OF REFERENCE NUMBERS

10 Printing tower

11 Printing unit

12 Printing couple

13 Transfer cylinder

14 Plate cylinder

15 Inking couple

16 Dampening unit

17 Printer

18 Ink fountain roller

19 Ink fountain

20 Film roller

21 Free space

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing unit of a web-fed rotary printing press comprising several printing couples, wherein each printing couple features a transfer cylinder, a plate cylinder, an inking couple and a dampening unit, wherein the transfer cylinder, the plate cylinder, and rollers of the inking couple and of the dampening unit of each printing couple, which rollers are drivable via a gear train starting from the transfer cylinder and/or the plate cylinder, are coupled on a drive side via gears and jointly positioned on side walls of the printing unit, and wherein an independently driven ink fountain roller of a respective inking couple together with an ink fountain as well as a film roller of the respective inking couple are positioned on separate side walls in such a way that, in a region of the respective printing couple, the ink fountain roller, the ink fountain as well as the film roller of the respective inking couple are displaceable relative to the cylinders and rollers of the respective printing couple, which cylinders and rollers are coupled via the gear train on the drive side, such that an access space is definable between the cylinders and rollers of the respective printing couple that are coupled via the gear train on the drive side and the ink fountain roller, the ink fountain as well as the film roller.

2. The printing unit according to claim 1, wherein, in the region of the respective printing couple, the ink fountain roller, the ink fountain as well as the film roller of the respective inking couple are translatorily displaceable relative to the cylinders and rollers of the respective printing couple that are coupled via the gear train on the drive side.

3. The printing unit according to claim 2, wherein the ink fountain roller, the ink fountain as well as the film roller of the respective inking couple are translatorily displaceable perpendicular to a longitudinal center axis of the transfer cylinder.

4. The printing unit according to claim 2, wherein the ink fountain roller, the ink fountain as well as the film roller of the respective inking couple are translatorily displaceable parallel to a longitudinal center axis of the transfer cylinder.

5. The printing unit according to claim 1, wherein the printing unit is comprised of four printing couples and wherein the ink fountain roller, the ink fountain as well as the film roller of respective inking couples of respective printing couples positioned in a stacked manner are jointly displaceable.

6. A printing unit of a web-fed rotary printing press, comprising:
a printing couple, including:
a transfer cylinder, a plate cylinder, and an inking couple, wherein the transfer cylinder, the plate cylinder, and rollers of the inking couple are coupled on a drive side via gears and jointly positioned on side walls of the printing unit; and
an independently driven ink fountain roller, an ink fountain, and a film roller positioned on separate side walls;
wherein the ink fountain roller, the ink fountain and the film roller are displaceable relative to the transfer cylinder, the plate cylinder, and the rollers of the inking couple such that an access space is definable between the ink fountain roller, the ink fountain, the film roller and the transfer cylinder, the plate cylinder, and the rollers of the inking couple.

7. The printing unit according to claim 6, wherein the ink fountain roller, the ink fountain, and the film roller are translatorily displaceable relative to the transfer cylinder, the plate cylinder, and the rollers of the inking couple.

8. The printing unit according to claim 7, wherein the ink fountain roller, the ink fountain, and the film roller are translatorily displaceable perpendicular to a longitudinal center axis of the transfer cylinder.

9. The printing unit according to claim 7, wherein the ink fountain roller, the ink fountain, and the film roller are translatorily displaceable parallel to a longitudinal center axis of the transfer cylinder.

10. The printing unit according to claim 6, wherein the printing couple further includes a dampening unit and wherein rollers of the dampening unit are coupled on the drive side via the gears and jointly positioned on the side walls of the printing unit.
